(19) United States
(12) Patent Application Publication
(10) Pub. No.: US 2016/0208695 A1
(43) Pub. Date: Jul. 21, 2016

(54) GAS TURBINE ENGINE INLET

(71) Applicant: John Charles Wells, Brighton (GB)

(72) Inventor: John Charles Wells, Brighton (GB)

(21) Appl. No.: 14/908,500

(22) PCT Filed: Jul. 16, 2014
(86) PCT No.: PCT/GB14/52162

§ 371 Date: Jan. 28, 2016

(30) Foreign Application Priority Data
Jul. 29, 2013 (GB) 1313454.9

(51) Int. Cl. F02C 7/057; F02C 7/042

(52) U.S. Cl. CPC F02C 7/057; F02C 7/042; F05D 2220/32

(57) ABSTRACT

In or for an aircraft turbine engine, the invention comprises a fitting comprising at least one blade, said blade being elongate and being adapted to be located such that it lies across the mouth of the engine inlet in use, such that, in use, the blade shears the air flowing towards it, such that the force of at least a portion of the air flowing Into the turbine is reduced, The invention also comprises a housing for a gas turbine engine, comprising a fitting of the invention and wherein the fitting is mounted at the, in use, front of the housing, the front of the housing having an inside periphery, and wherein the fitting is mounted within the inside periphery of the housing,

### FIELD OF THE INVENTION

The invention is in the field of gas turbine engines used in aviation.

### BACKGROUND

A gas turbine, also called a combustion turbine, has an upstream rotating compressor coupled to a downstream turbine, and a combustion chamber in between. In use, the gas turbine operates thus; fresh atmospheric air flows through an net and a compressor that increases the pressure of the air. Energy is then added by spraying fuel into the air and igniting it so the combustion generates a high-temperature flow. This high-temperature, high-pressure gas enters a turbine, where it expands up to the exhaust pressure, producing a shaft work output in the process. The turbine shaft work is used to drive the compressor and other devices such as an electric generator that may be coupled to the shaft. The energy that is not used for shaft work comes out in the exhaust gases, so these have either a high temperature or a high velocity. The gas turbine is commonly used in aviation.

In a practical gas turbine, gases are first accelerated in either a centrifugal or axial compressor. These gases are then slowed using a diverging nozzle known as a diffuser. In the case of a jet engine only enough pressure and energy is extracted from the flow to drive the compressor and other components; this is often done by way of a “bypass”. The remaining high pressure gases are accelerated to provide a jet that can, for example, be used to propel an aircraft.

The air let into the turbine engine is most often through the inlet of the engine, at the front. During flight, the aeroplane to which the turbine is attached is generally travelling at a high speed. The net aerodynamic force acting in the opposite direction to the direction of travel of the aircraft is considerable, and the air which is introduced to the turbine during flight is therefore relatively difficult to move.

Two problems are present during the introduction of the air into the turbine and compressor. The first is the general problem of drag acting on the inside of the turbine housing the resistance of the air must be compensated for or overcome in order to maximise the fuel and energy efficiency of the turbine and to ameliorate generally the energy sapping effects of drag.

The second problem is that the flow of air must be redirected in order that it can be usefully used in the turbine. The compressor is thus often tasked to a large extent with this redirecting which deleteriously expends energy and or puts a strain on the turbine and its housing, which reduces the useful life of the turbine and its components.

With fuel costs rising, there is a real need to find ways of reducing the drag generated by high speed air travel on the interior of gas turbines and of efficiently redirecting the flow of air such that it can be efficiently compressed, processed and outputted by the given turbine.

It is a solution to these and other problems which the inventions described herein attempt to solve.

### SUMMARY OF THE INVENTION

In a first broad, independent aspect, in or for an aircraft turbine engine, the invention comprises a fitting comprising at least one blade, said blade being elongate and being adapted to be located such that it lies across the mouth of the engine inlet in use, such that, in use, the blade shears the air flowing towards it, such that the force of at least a portion of the air flowing into the turbine is reduced.

By exerting a shearing force on the airflow which would otherwise travel in a linear path until encountering the gas turbine engine itself, the blade serves to redirect some of the flow of air and also to reduce the force exerted by the air as it is flows relative to the turbine, being deflected obliquely from its linear path.

By beneficially redirecting the air such that the compressor is required to exert a lesser force in order to divert the path of the air into the desired direction, greater fuel efficiency is achieved. Thus the airflow is made to tend towards the direction of rotation of the compressor in the gas turbine.

Preferably, the blade has a substantially flattened surface along its length.

The flattened surface optimises resistance against airflow.

Preferably, the blade has a first side and a second side and at least the first side exhibits a portion of convexity along its length.

The portion of convexity provides a further option in order to optimise resistance to airflow.

Preferably, the blade has a first side and a second side and at least the second side exhibits a portion of concavity along its length.

The portion of concavity provides a still further means of optimising the resistance against airflow.

Preferably, the blade has a first side with a portion of convexity along its length and a second side with a portion of concavity along its length and wherein the portion of convexity and the portion of concavity are located along their respective sides such that they are substantially parallel to one another.

The substantially parallel portions of concavity and convexity provide a particularly preferred scimitar-style configuration which optimises resistance to airflow and refractive power.

Preferably, the blade is adapted to be located inside the mouth of the engine net in use. This location minimises the deleterious effect of the installation of the fitting to the shape of the engine containment bay housing or nacelle to which it is fixed.

Preferably, the blade is adapted to be located outside the mouth of the engine inlet in use.

Locating the blade here may serve to provide optimal resistance and a more favourable angle of refraction to the air which hits it.

Preferably, the invention comprises a rotatable joint between the blade and the mounting means whereby the blade may be rotated axially, relative to the mounting means.

Rotatable blades vis-à-vis mounting means allow for the adjustment of the angle of the blade or blades relative to the airflow in order to optimise resistance and refraction.

Preferably, there is a plurality of blades arranged concentrically around a hub.

A concentric arrangement of blades provides structural strength to the fitting as well as advantageously mimicking the concentric arrangement of the fan blades situated, in use, behind the fitting; thus, the optimal configuration of blades is provided. Axial rotation relative to the hub allows each individual “spoke” of a given configuration of blades to be angled independently such that each can be arranged to respond to environmental conditions such that optimal shearing i.e. for subtraction/amelioration of force-related stress and refraction of air can be achieved. The configuration comprising multiple overlying blades provides a further advantageous configuration of blades.

More preferably, the hub is a component of the mounting means, and comprises at least one rotatable joint, such that the blade may be rotated axially relative to the hub.

Rotatable blades may be adjusted in position relative to the turbine itself such that the attributes of resistance and redirection can be dynamically optimised—adjusted in accord to environmental conditions—such as weather for example—which affect airflow.

More preferably, the invention comprises a first blade and a second blade, wherein the blades are perpendicularly disposed relative one another, and wherein the first blade overlies the second blade, such that the blades cross, and wherein the point at which the blades cross is substantially midway along each of the blades.

More preferably, the blades are joined at the midpoint at which they cross.

More preferably, the point at which the blades cross is coaxial with the central axis of the turbine to which, in use, the fitting is to be fitted.

Preferably, in use, the blades comprise a cruciform grille across the inlet of the turbine engine

Joining the blades in a cruciform shape and other such crossing configurations provide a means of reinforcing the fitting such that it optimally resists and/or refracts the airflow but such that it also provides for a durable, strong structure which will survive repeated aeroplane flights and therefore uses.

Preferably, the blade comprises a Linear series of aerofoil shaped sections.

The plurality of aerofoils, creating a scalloped profile is a particularly effective blade shape or configuration.

Preferably, the blade comprises a tunnel, running at least a portion of the length of the fitting.

The tunnel has a dual function. The first function is to reduce the weight of the fitting. The second is to provide a means for housing in some embodiments the necessary components to rotate or to otherwise move the component blades of the fitting or other items or both.

More preferably, the fitting is in fluid communication with a source of de-icing fluid and pumping means, such that in use, the de-icing fluid may be passed into and out of the tunnel.

The presence of a de-icing system advantageously ensures that the blade may operate in freezing conditions.

More preferably, the blade comprises a length of electrically conductive material with means to attach it to a source of electricity.

Likewise, the electrically conductive material provides a means of heating the blades such that they can be prevented from freezing in freezing conditions.

Preferably, the blade has a first side with a plurality of portions of convexity along its length and a second side with a plurality of portions of concavity along its length; wherein the plurality of portions of convexity and concavity are arranged in increments; and wherein the portions of convexity and the portions of concavity are located along their respective sides such that they are substantially parallel to one another. This is a particularly effective blade shape or configuration as the plurality of portions of convexity and concavity augment the effect of the blade on oncoming airflow in order to increase the efficiency of the engine.

Preferably, the blade incorporates an angled tip, at a portion of the blade adjacent to the hub, which is angled away from the hub. This configuration is particularly advantageous because it augments the shearing or air redirection effect on the oncoming airflow into the engine in order to further cause the oncoming air to ‘swirl’ prior to entering the low pressure fan which increases the efficiency of the engine.

Preferably, the invention comprises a retraction means which is attached to the blade such that the blade is capable of being retracted when not in use. This is particularly advantageous because it allows the blade to only be utilised when needed to shear the airflow so as not to unduly obstruct the airflow when the blade is not required so that the efficiency of the engine is not jeopardised.

The invention also comprises a fitting substantially as described herein, with reference to and as illustrated by any appropriate combination of the text and drawings.

In a second broad, independent aspect, the invention comprises a fitting according to any of the preceding claims and wherein the fitting is mounted at the, in use, front of the housing, the front of the housing having an inside periphery, and wherein the fitting is mounted within the inside periphery of the housing.

The engine housing with integrated fitting provides an advantageous alternative to the retro fitted fitting in the sense that the join between engine housing and fitting may be more secure and seamless such that the fitting is merely part of the engine housing unit.

Preferably, said fitting comprises a retraction means such that the fitting is capable of being retracted at least partially into said housing. This configuration is particularly w advantageous because it allows the fitting to be utilised only when needed to shear the airflow so as not to unduly obstruct the airflow when not required so that the efficiency of the engine is not jeopardised.

The invention also comprises a housing substantially as described herein, with reference to and as illustrated by any appropriate combination of the text and drawings.

### BRIEF DESCRIPTION OF THE DRAWINGS

The invention will now be described with reference to the figures of which:

FIG. 1 is a diagrammatic side view of a first embodiment of the invention;

FIG. 2 is a diagrammatic side view of a second embodiment of the invention;

FIG. 3 is a diagrammatic side view of a third embodiment of the invention;

FIG. 4 is a diagrammatic side view of a fourth embodiment of the invention;

FIG. 5 is a diagrammatic side view of a fifth embodiment of the invention;

FIG. 6 is a diagrammatic side view of a sixth embodiment of the invention;

FIG. 7 is a diagrammatic side view of a seventh embodiment of the invention;

FIG. 8 is a diagrammatic side view of an eighth embodiment of the invention;

FIG. 9 is a diagrammatic view of the invention as installed in a gas turbine engine;

FIG. 10 is a diagrammatic cross-sectional view of a blade of the invention;

FIG. 11 is a diagrammatic side view of the invention as installed in a gas turbine engine;

FIG. 12 is a diagrammatic side view of a ninth embodiment of the invention; and

FIG. 13 is a diagrammatic side view of a tenth embodiment of the invention.

### DETAILED DESCRIPTION OF THE PREFERRED EMBODIMENTS

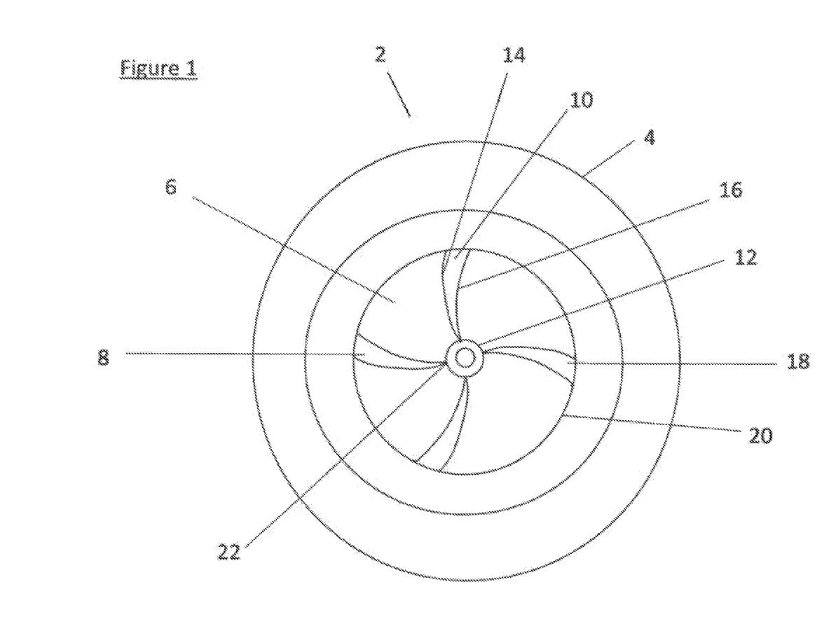

At FIG. 1 there is shown a gas engine turbine indicated generally at 2 comprising an engine containment bay or nacelle 4, an inlet 6 and a fitting 8. The fitting 8 forms a baffle or grill and serves to partially obstruct the flow of air through the net 6, such that the course of the air may be changed in order that the air can be beneficially introduced to the moving parts of the turbine 2, notably the compressor fan. The fitting 8 serves to reduce the force which the air travelling into the turbine 2 hits the internal components of the said turbine 2, and also serves to shear the air, changing its course in order that its introduction through the inlet 6 to the low pressure fan (not shown), for example, are in a manner which decreases the effort required to be exerted by the turbine 2 in order to move the air in a beneficial direction. As such, the fuel efficiency of the turbine 2 and therefore the overall emery efficiency of the turbine 2 are increased.

The fitting 8, which will be made from metals, alloys or other materials or combinations of materials picked for strength and ability to resist the conditions to which the turbine 2 is exposed in use, comprises at least one blade 10, in some embodiments the blades are constructed of a material or materials, such as a flexible metal material, which by their nature allow controlled “distortion” or “warp” without compromising the effectiveness of safety of the fitting 8. The configuration of the blades 10 or foils may be subject to experimentation in order to provide the optimal configuration of said blades 10. At FIG. 1 there are four blades 10 arranged concentrically around a hub 12 with said hub 12 being coaxially located relative to the compressor fan (not shown).

In this embodiment, each blade 10 comprises a convex first edge 14 and a concave second edge 16 with each of the two edges 14, 16 comprising a continuous curve from first end 18, which is proximate to wall 20 of inlet 6 tapering to distal end 22 adjacent hub 12. Generally desirable an aerofoil shaped blade 10 is considered to be particularly desirable.

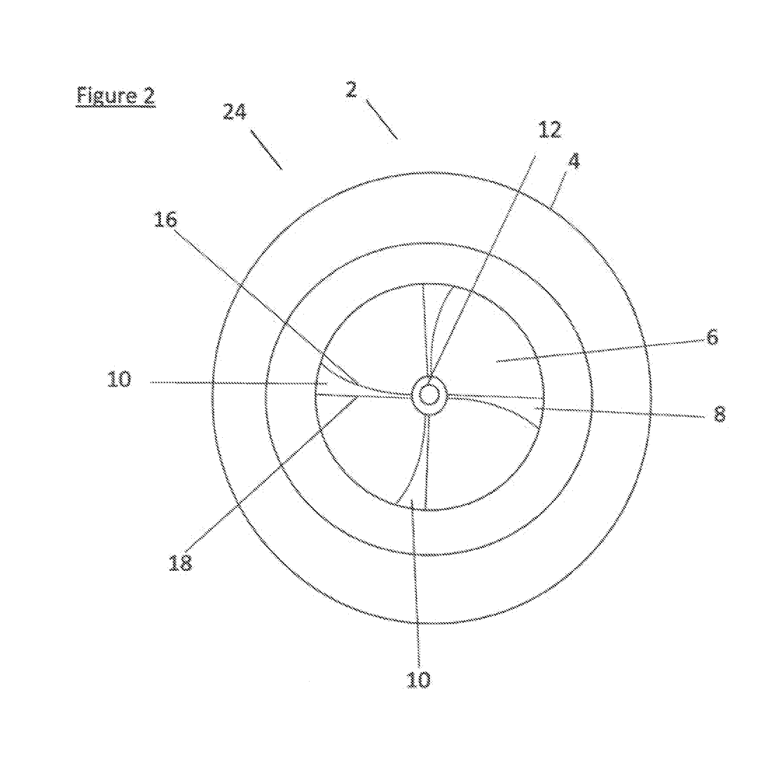

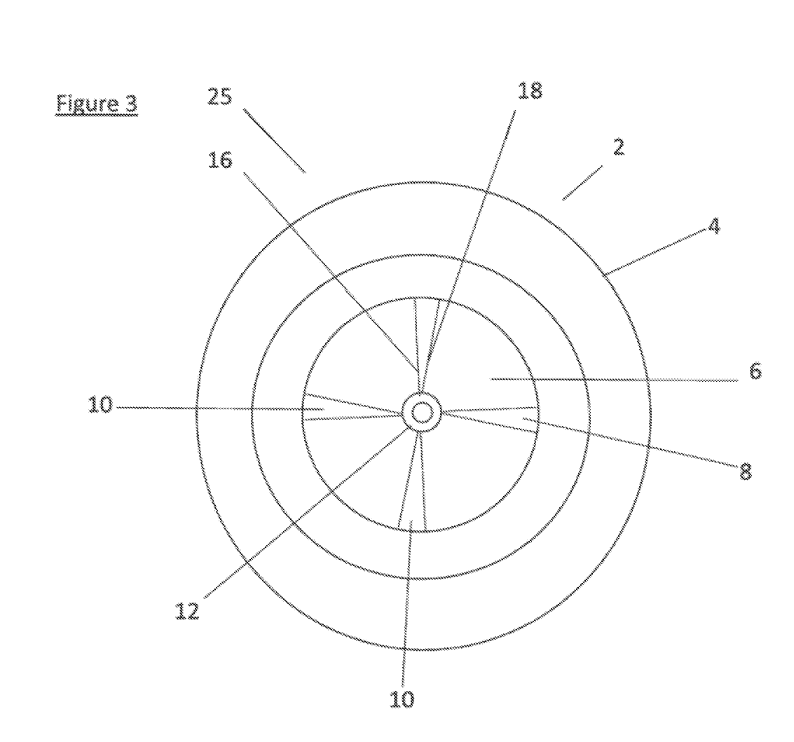

FIG. 2 shows a second embodiment of the invention 24, having blades 10 with a concave second edge 16 and a straight first edge 14. A third embodiment 25 at FIG. 3 shows blades 10 with straight first and second edges 14, 16.

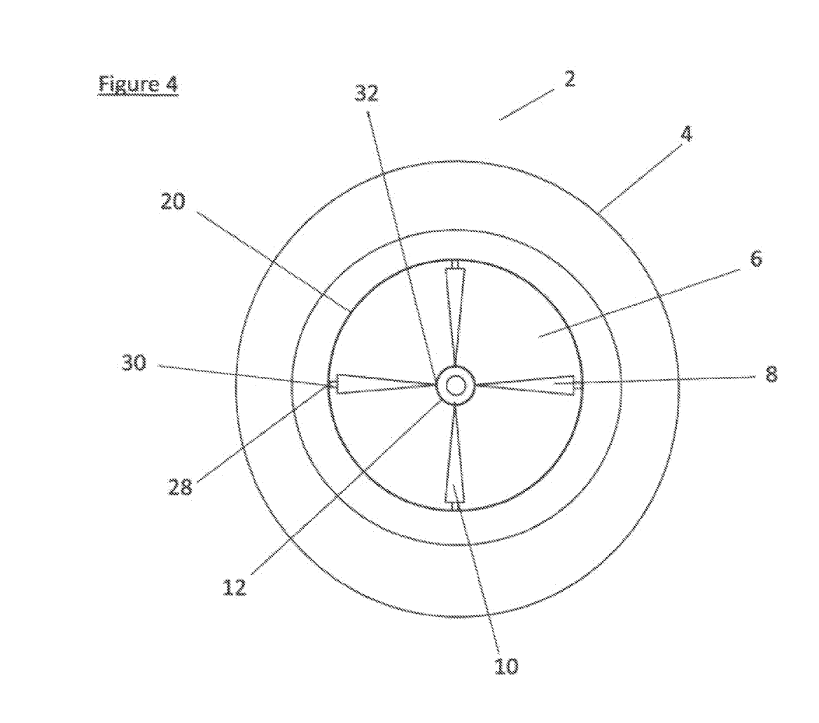

At FIG. 4, the fourth embodiment 26 shows blades 10 mounted on mounting means 28. Mounting means 28 comprises inner wall contacting component 30 and hub contacting component 32. The blade 10 can move axially relative to mounting means 28. Such axial rotation may be performed manually, or preferable automatically via one or more motors and a control system of known type which may comprise an automatic sensoring feedback adjustment system, of be connected to a GPS system for detecting weather patterns. Alternatively the motors may be manually controllable by pilot or navigator via cockpit controls. The axial rotation or swivelling of each of the blades 10 allows for changing of the aspect of the blade 10 presented to the flow of air travelling into the inlet 6. The blades 12 do not rotate radially.

In an alternative embodiment, the blades 10 are fixed at an optimum angle to provide the maximum efficiency.

In embodiments where the blades 10 are moveable, that movement, either vertically or linearly, is typically powered via hydraulic or electric power.

In some embodiments there may be a discontinuity between the blade 10 and the inner wall 20 where the joint is located.

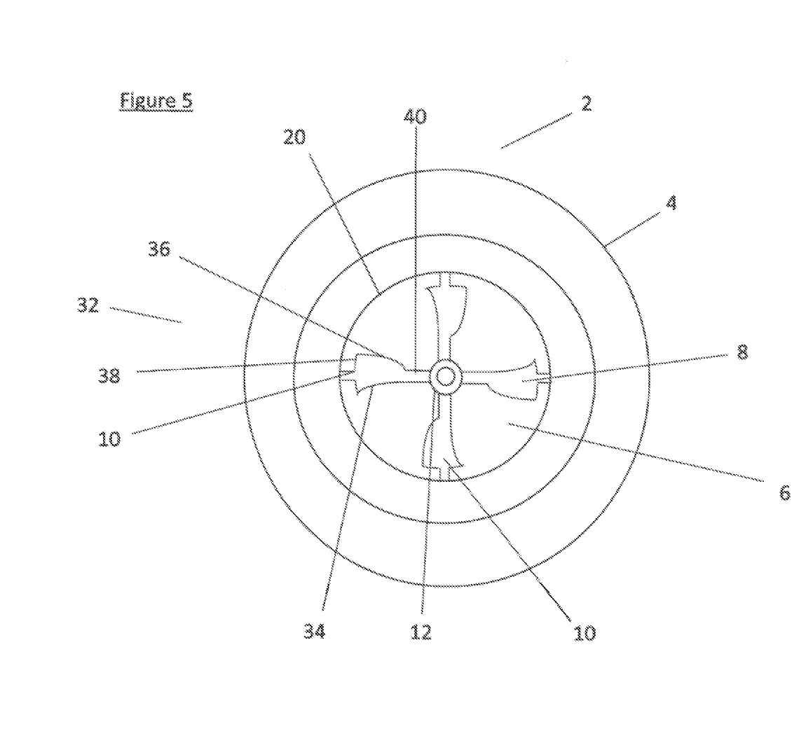

FIG. 5 shows a fifth embodiment of the invention 32 with blades 10 showing this discontinuity. The blades 10 are each arranged relative to each other in a scimitar shape with a concave first edge 34 and a convex second edge 36 and having a widest point at a point proximal to the inner wall 20 and tapering towards the hub 12. In this particularly preferred embodiment, the taper of the concave first edge 34 and the convex second edge 36 do not follow an identically continuous curve—in other words the curves of the respective edges 34 and 36 are not parallel to one another. The convex curve of the second edge 36 progressively steepens in gradient before meeting flattened portion 40, in other embodiments, the blades themselves have at Least one flat surface.

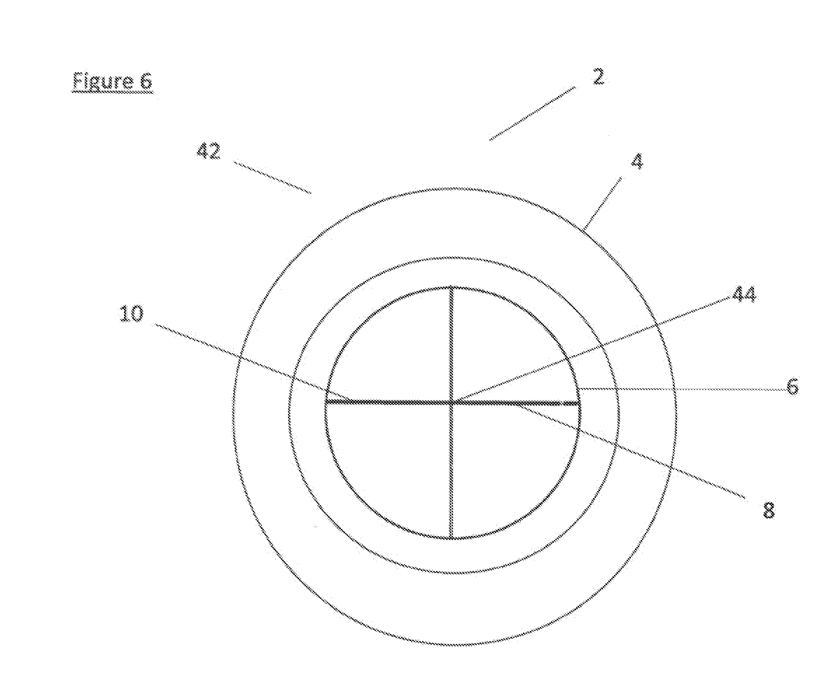

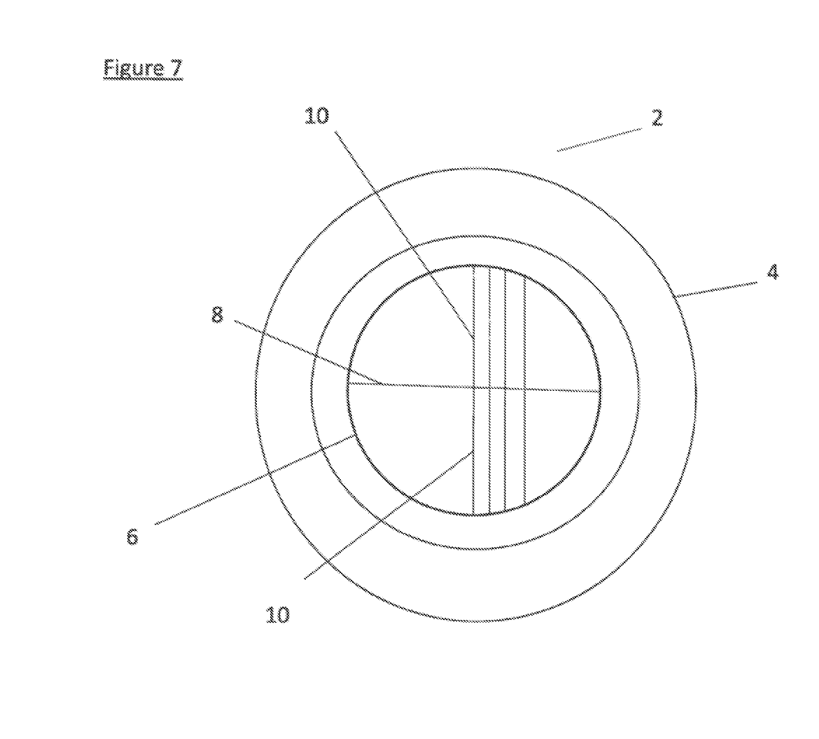

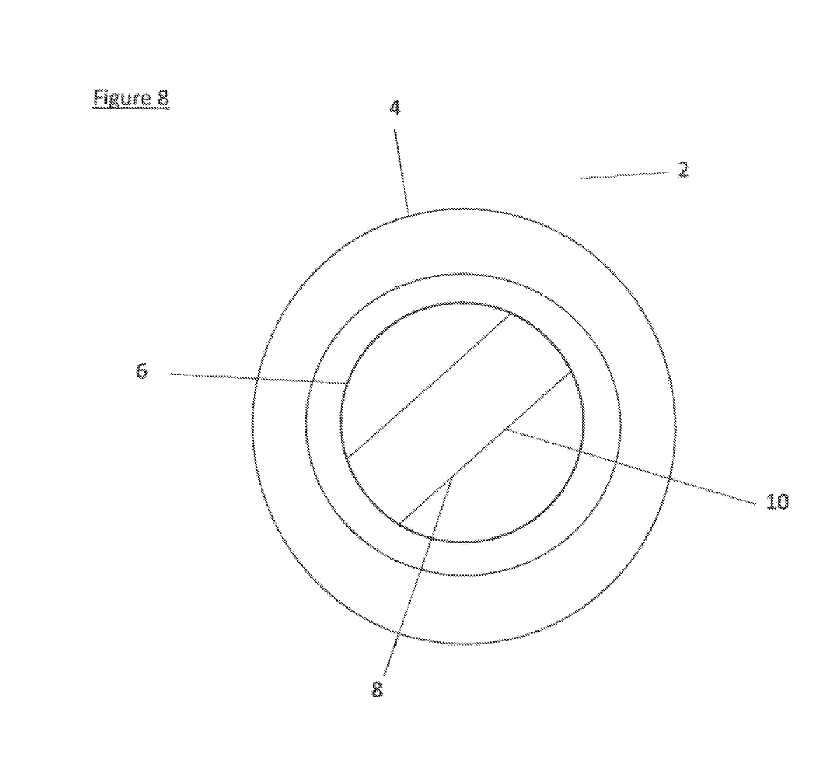

At FIG. 6 a cruciform grille of blades 10 is shown in a sixth embodiment 42 of the invention. These fixed blades 10 span the entire width of the inlet 6 of the turbine 2 and are conjoined at the crossing point or centre 42. This provides an advantage over having a hub in that it minimises the obstruction to the airflow in the centre or crossing point 42 of the blades 10.

A seventh embodiment 46 comprises an asymmetrical array of blades 12, it is also illustrative of the fact that although advantageous, the meeting of the blades 10 need not be concentric with the turbine fan.

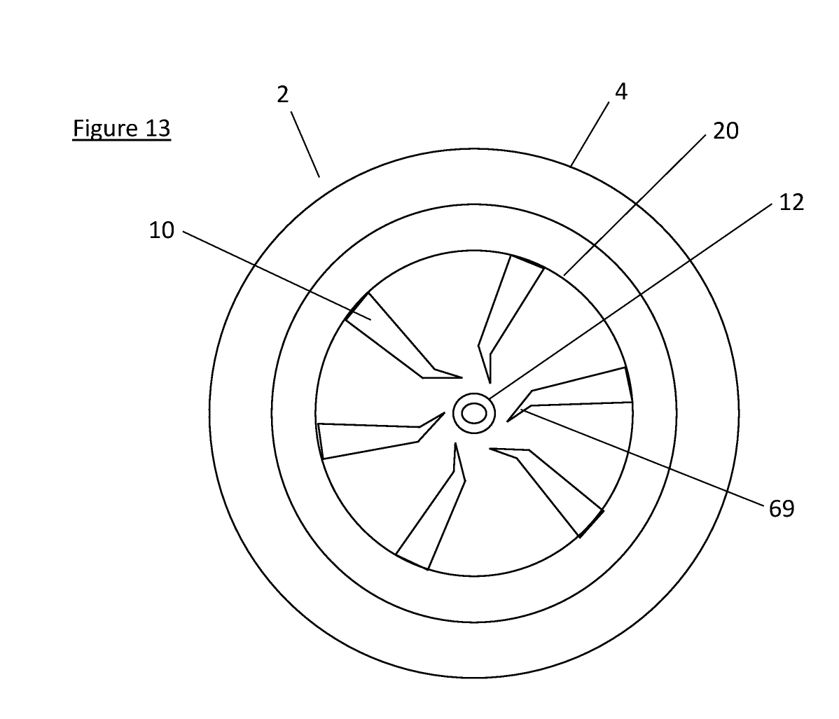

In a further embodiment, shown in FIG. 12, each of the blades 10 has a first side With plurality of portions of convexity along its length and a second side with a plurality of portions of concavity along its length; wherein the plurality of portions of convexity and concavity are arranged in increments; and wherein the portions of convexity and the portions of concavity are located along their respective sides such that they are substantially parallel to one another. This creates an optimum shape for shearing the airflow. In an alternative embodiment, shown in FIG. 13, each blade 10 has an angled tip 69, at a portion of the blade 10 adjacent to the hub 12, which is angled away from the hub 12. The angled tip 69 of the blade 10 augments the shearing effect on the oncoming airflow into the engine in order to further cause the oncoming air to swirl prior to entering the low pressure fan.

In a further embodiment, a retraction means (not shown) is provided, which allows the blades to be capable of being retracted, at least partially, when not in use in order to allow the maximum airflow into the engine if necessary. This ensures that the efficiency of the engine is maximised at all times and that the flow of air into the inlet is not jeopardised when the blades are not required. Preferably, when they are not required, the blades 10 are fully retracted and lie flush with the wall of the engine containment bay 4. When required, the blades 10 can then be moved into a position for shearing the airflow. This configuration also allows the blades 10 to be partially retracted or moved in order to create the most optimum position for shearing the airflow. Retraction of the blades 10 may be towards the low pressure fan or towards the containment bay 4. It is also envisaged that each of the blades 10 is capable of being moved closer to or further away from the low pressure fan. In both circumstances, it is envisaged that ingested air is used to move the blades 10 towards the fan or to retract the blades, and power is only used to move the blades further away from the fan or to engage the blades 10 from their retracted position.

At FIG. 10 there is shown a blade 10 in cross-section. The blade comprises a wall 50 and a cavity 52 which may run along all or part of the said blade 10. The cavity 52 may advantageous comprise conductive materials suitable for passing electricity through which may be connected to an electricity supply. Alternatively the cavity 52 may be in fluid connection with a supply or a pumping means for feeding de-icing fluid through the said blade 10. Each of these provides a means of ensuring that the blade 10 does not freeze and thus does not become unable to rotate or structurally compromised.

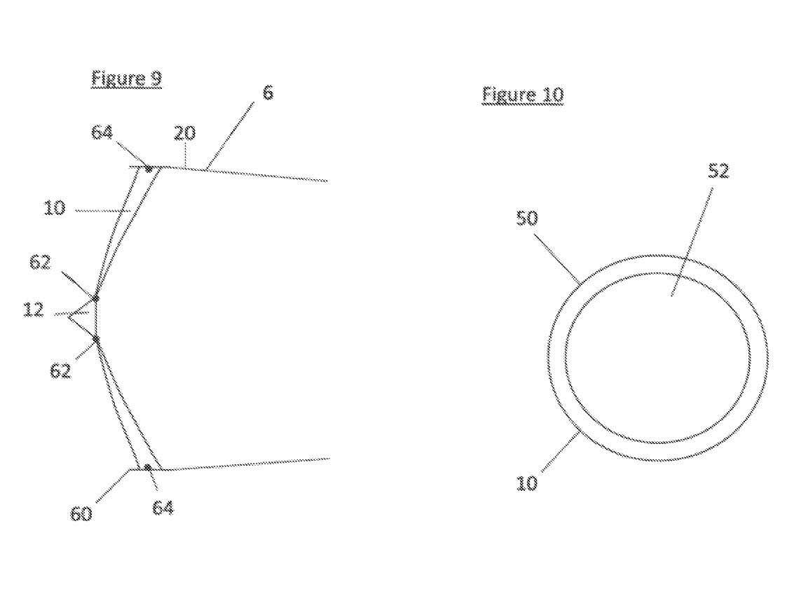

At FIG. 9, the blades 10 are shown mounted to the inner wall 20 of the inlet 6. The blades meet at hub 12. The hub 12 is shown to be free floating and blades 10 are shown to project from inner walls 20 of inlet 16 such that they are outside terminus 60 of the inlet 6. The points of rotation adjacent hub 62 and adjacent inner wall 64 are also shown. Rotation may be achieved via known means including solenoids.

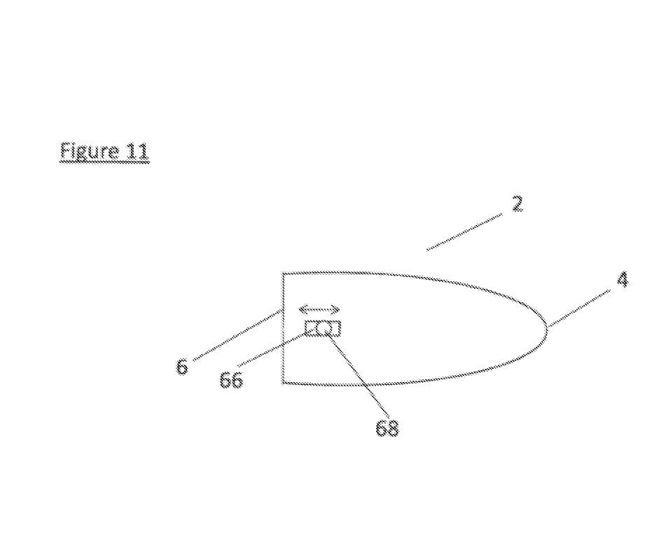

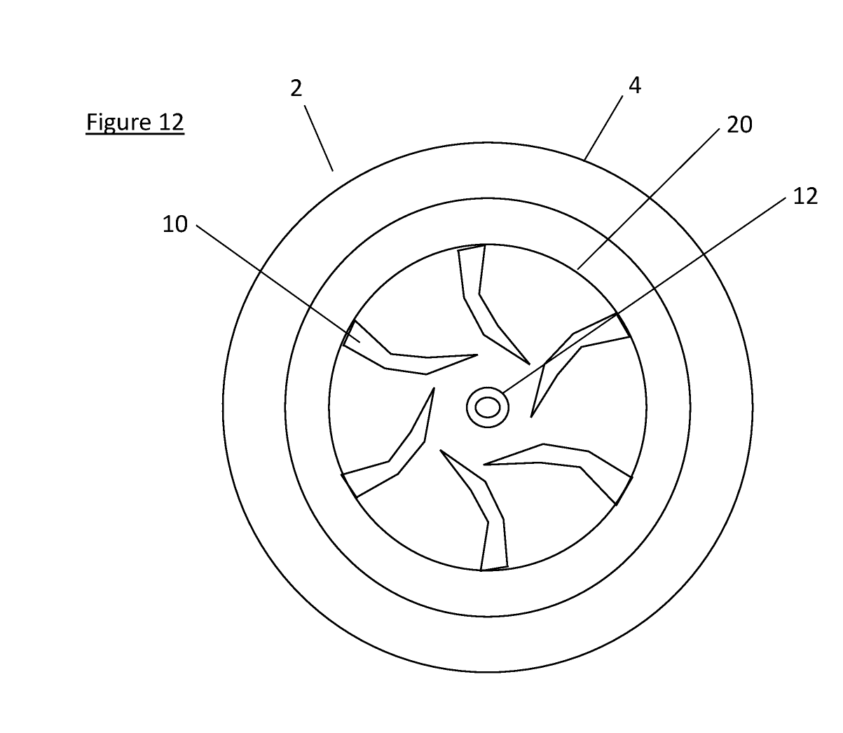

At FIG. 11, there is shown an engine containment bay 4, comprising a slot 66 in its wall, wherein the blade 10 can be moved laterally towards and away from the compressor fan. Whilst in this embodiment, the slot 66 is shown to be a part of the inlet 6, it could equally be a portion of a retrofit part attached to the front of the said inlet 6, however, integrating it into the inlet 6 should be thought of as preferable, since weight is saved by so doing. In this embodiment, optionally the radial edge of the blade 10 is bowed, with the apex of the bow being substantially centred over the inlet 6, and wherein the blade comprises projections 68 such that the blade 10 is fixed in the slots 66 and as such can be rotated via actuation means (not shown) as well as moved laterally.

1-25. (canceled)

26. In or for an aircraft turbine engine with an engine inlet incorporating a mouth, a fitting comprising at least one blade, said blade being elongate and lying across the mouth of the engine inlet in use, such that the blade shears the air flowing towards it, such that the force of at least a portion of the air flowing into the turbine is reduced.

27. A fitting according to claim 26, wherein the blade has a substantially flattened surface along its length.

28. A fitting according to claim 26, wherein the blade has a first side and a second side and at least the first side exhibits a portion of convexity along its length.

29. A fitting according to claim 26, wherein the blade has a first side and a second side and at least the second side exhibits a portion of concavity along its length.

30. A fitting according to claim 26, wherein the blade has a first side with a portion of convexity along its length and a second side with a portion of concavity along its length and wherein the portion of convexity and the portion of concavity are located along their respective sides such that they are substantially parallel to one another.

31. A fitting according to claim 26, comprising a mount and a rotatable joint; wherein said rotatable joint is located between the blade and the mount whereby the blade may be rotated axially, relative to the mount.

32. A fitting according to claim 26, wherein there is a plurality of blades arranged concentrically around a hub.

33. A fitting according to claim 32, wherein the hub is a component of the mount and comprises at least one rotatable joint, such that the blade may rotated axially relative to the hub.

34. A fitting according to claim 26, comprising a first blade and a second blade, wherein the blades are perpendicularly disposed relative one another, and wherein the first blade overlies the second blade, such that the blades cross, and wherein the point at which the blades cross is substantially midway along each of the blades.

35. A fitting according to claim 26, wherein, in use, the blades comprise a cruciform grille across the inlet of the turbine engine.

36. A fitting according to claim 26, wherein the blade comprises a linear series of aerofoil shaped sections.

37. A fitting according to claim 26, wherein the blade comprises a tunnel, running at least a portion of the length of the fitting.

38. A fitting according to claim 26, wherein the blade has a first side with a plurality of portions of convexity along its length and a second side with a plurality of portions of concavity along its length; wherein the plurality of portions of convexity and concavity are arranged in increments; and wherein the portions of convexity and the portions of concavity are located along their respective sides such that they are substantially parallel to one another.

39. A fitting according to claim 26, wherein the blade incorporates an angled tip, at a portion of the blade adjacent to the hub, which is angled away from the hub.

40. A fitting according to claim 26, comprising a retractor which is attached to the blade such that the blade is capable of being retracted when not in use.
